(19) United States
(12) Patent Application Publication
(10) Pub. No.: US 2023/0008093 A1
(43) Pub. Date: Jan. 12, 2023

(54) AIRCRAFT FLOORING SYSTEM

(71) Applicant: Aladdin Manufacturing Corporation, Calhoun, GA (US)

(72) Inventors: Martin Shamis, Calhoun, GA (US); Nathan Stevenson, Calhoun, GA (US)

(21) Appl. No.: 17/757,620

(22) PCT Filed: Dec. 16, 2020
(86) PCT No.: PCT/US2020/065313

§ 371 Date: Jun. 17, 2022

Related U.S. Application Data
(60) Provisional application No. 62/949,818, filed on Dec. 18, 2019.

(30) Foreign Application Priority Data
Jan. 31, 2020 (EP) 20154794.0

(51) Int. Cl. B64C 1/18; B32B 3/06; B32B 27/12; B32B 27/36; B32B 5/02; B32B 7/12

(52) U.S. Cl. CPC B64C 1/18; B32B 3/06; B32B 27/12; B32B 27/36; B32B 5/024; B32B 7/12; B32B 5/028; B32B 5/022; B32B 2605/18; B32B 2471/02; B32B 2605/003; B32B 2307/748; B32B 2307/542; B32B 2307/54; B32B 2307/718

(57) ABSTRACT

An aircraft flooring system is provided, made up of a low-weight carpet tile which functions both as a moisture barrier and as the loop part of a hook-and-loop system, for coupling to a hook part of a hook-and-loop system, which is bound to an aircraft floor. Specifically, a barrier backing within the carpet tile, comprising a nonwoven fabric portion, is able to act as the moisture barrier and the loop part, which allows for coupling of the carpet tile with the floor, without the need to add additional loops to the carpet tile, thereby realizing savings in material cost and weight.

### CROSS-REFERENCE TO RELATED APPLICATIONS

The present application claims the benefit of priority of U.S. Patent Application No. 62/949,818 filed on Dec. 18, 2019, and European Patent Application No. 20154794.0 filed on Jan. 31, 2020, the contents of which are hereby incorporated by reference in their entirety for all purposes.

### BACKGROUND

Carpeting on airplanes presents a number of challenges not always found in a terrestrially-based carpet installation. For example, weight is of paramount importance during the selection of components for installation in aircraft, whereas it may not be a factor in selecting carpeting for an office building.

Containment of spills is also a factor on airplanes; there are often bolts, electronics, or wiring in panels under the carpet, and liquid reaching these components could have severe consequences. Spills are frequent occurrences on airplanes, as passengers often have beverages on trays, and limited space in which to maneuver themselves. Short turnaround times at airports, during which airplanes must be cleaned between flights, mean that making spills easier to clean up would benefit cleaning crews.

Further, carpet tiles are often undesirable for use as airplane carpeting, due to the increased presence of seams, compared to broadloom carpeting. Seams between tiles provide another avenue for liquids to find their way under the carpet.

Accordingly, a need exists for carpet tiles having a light weight and exhibiting resistance to spills, for use as airplane carpeting.

### BRIEF SUMMARY

According to the first aspect of the invention, an aircraft floor covering system is provided, said system comprising:
a) a carpet tile, said carpet tile comprising a barrier backing, said barrier backing comprising a top surface and a bottom surface, said top surface adhered to a polymer membrane, said bottom surface comprising a loop part of a hook-and-loop system; and
b) a hook part of a hook-and-loop system adhered to an aircraft floor,

wherein the barrier backing is coupled to the hook part of the hook-and-loop system.

### BRIEF DESCRIPTION OF THE SEVERAL VIEWS OF THE DRAWINGS

Reference will now be made to the accompanying drawings, which are not necessarily drawn to scale, and wherein:

FIG. 1 is a side cutaway view showing various components of a carpet tile according to one embodiment;

FIG. 2 is a schematic diagram of a carpet tile and a flooring system, comprising loops and hooks of a hook-and-loop system, respectively, in close proximity to one another, according to one embodiment; and

FIG. 3 is a schematic diagram showing the carpet tile and flooring of FIG. 2 coupled to one another by a hook-and-loop system.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

In the following description, various components may be identified as having specific values or parameters, however, these items are provided as exemplary embodiments. Indeed, the exemplary embodiments do not limit the various aspects and concepts of the embodiments as many comparable parameters, sizes, ranges, and/or values may be implemented. The terms “first,” “second,” and the like, “primary,” “exemplary,” “secondary,” and the like, do not denote any order, quantity, or importance, but rather are used to distinguish one element from another. Further, the terms “a,” “an,” and “the” do not denote a limitation of quantity, but rather denote the presence of “at least one” of the referenced item.

It is understood that where a parameter range is provided, all integers and ranges within that range, and tenths and hundredths thereof, are also provided by the embodiments. For example, “5-10%” includes 5%, 6%, 7%, 8%, 9%, and 10%; 5.0%, 5.1%, 5.2% . . . . 9.8%, 9.9%, and 10.0%; and 5.00%, 5.01%, 5.02% . . . . 9.98%, 9.99%, and 10.00%, as well as, for example, 6-9%, 5.1%-9.9%, and 5.01%-9.99%.

As used herein, “about” in the context of a numerical value or range means within ±10% of the numerical value or range recited or claimed.

Various embodiments are directed to a low-weight, dimensionally stable carpet, particularly carpet tiles, that is resistant to both doming and curling. The carpet is a multi-layer carpet comprising a facecloth (comprising a primary backing and face yarn), coated with a low-viscosity polyolefin), bonded to a backing construction comprising a fibrous reinforcing scrim layer (e.g., woven or nonwoven) and an extruded polyolefin sheet, wherein the backing construction defines, at least in part, the bottom surface of the carpet. The low weight carpet product has a total weight of less than 60 ounces per square yard while remaining resistant to deformation (dimensional deformation, curling, or doming) due at least in part to the presence of the reinforcing scrim layer in the backing construction.

According to the first aspect of the invention, an aircraft floor covering system is provided, said system comprising:
a) a carpet tile, said carpet tile comprising a barrier backing, said barrier backing comprising a top surface and a bottom surface, said top surface adhered to a polymer membrane, said bottom surface comprising a loop part of a hook-and-loop system; and
b) a hook part of a hook-and-loop system adhered to an aircraft floor,

wherein the barrier backing is coupled to the hook part of the hook-and-loop system.

According to some embodiments, said polymer film membrane is a polyester membrane.

According to some embodiments, said carpet tile comprises a facecloth, wherein the facecloth comprises a primary backing having a plurality of face yarns extending through the primary backing.

According to some embodiments, adhesive is present between the primary backing and the polymer membrane.

According to some embodiments, said bottom surface of said barrier backing comprises loops in a density of ≥500 loops per square inch.

According to some embodiments, said hook part of said hook-and-loop system comprises hooks in a density of ≥500 hooks per square inch.

According to some embodiments, said hook-and-loop system, when coupled, exhibits a peel strength of ≥1, ≥2, ≥3, ≥4, ≥5, ≥6, ≥7, ≥8, ≥9, or ≥10 pounds per inch of width (PIW), as measured according to ASTM D5170.

According to some embodiments, said hook-and-loop system, when coupled, exhibits a shear strength of ≥5, ≥10, ≥15, ≥20, ≥25, ≥30, ≥35, ≥40, ≥45, ≥50, ≥55, ≥60, ≥65, ≥70, ≥75, ≥80, ≥85, or ≥90 pounds per square inch (psi) as measured according to ASTM D5169.

According to some embodiments, said hook-and-loop system, when coupled, exhibits a tension strength of ≥5, ≥10, ≥15, ≥20, ≥25, ≥30, ≥35, ≥40, or ≥45 pounds per square inch (psi).

According to some embodiments, said carpet tile further comprises a woven synthetic layer disposed between the polymer membrane and the primary backing.

According to some embodiments, adhesive is present between the woven synthetic layer and each of the primary backing and the polymer membrane. According to some further embodiments, the adhesive between the woven synthetic layer and the primary backing is the same as the adhesive between the woven synthetic layer and the polymer membrane. According to some alternative embodiments, the adhesive between the woven synthetic layer and the primary backing is different from the adhesive between the woven synthetic layer and the polymer membrane.

According to some embodiments, the hooks are attached directly to the aircraft floor.

According to some alternative embodiments, the hooks are part of a flooring component which is bound to the aircraft floor.

According to some embodiments, the weight of the carpet tile is between about 30-60 ounces per square yard. According to some further embodiments, the weight of the carpet tile is between about 40-50 ounces per square yard.

According to some embodiments, the weight of the carpet tile and flooring, combined, is between about 40-90 ounces per square yard. According to some further embodiments, the weight of the carpet tile and flooring, combined, is between about 50-70 ounces per square yard.

Carpet Tile

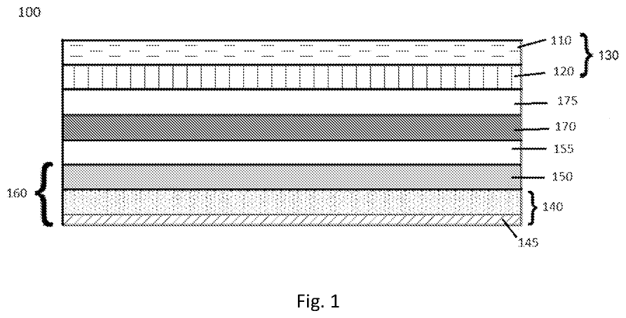

Referring to the figures, in which like numerals refer to like elements through the several figures, FIG. 1 illustrates schematically (not to scale) one potential construction of the carpet tile. It is generally designated by reference numeral 100. The carpet tile 100 includes face yarn 110, which is tufted into a mesh, woven, or spunbonded fabric known as a primary backing 120. The primary backing 120 has pile yarns 110 tufted therethrough extending outwardly from one face (the “top”). In the construction shown in FIG. 1, the other side of the primary backing 120 (the “bottom”) is secured to one face of a reinforced woven synthetic layer 170, secured by an adhesive layer 175. The other face of the reinforced woven synthetic layer 170 is secured to a polymer membrane 150, by a second adhesive layer 155. The polymer membrane 150, in turn, is secured to a nonwoven fabric 140. A plurality of loops 145, which may form part of a hook-and-loop system, is part of the nonwoven fabric 140. The polymer membrane 150 and the nonwoven fabric 140, combined, may be referred to as a barrier backing 160 (or “lower backing”). Face yarn 110 and primary backing 120, combined, may be referred to as a facecloth 130. In embodiments without the reinforced woven synthetic layer 170, and consequently without adhesive layer 175, the bottom face of the primary backing 120 is secured to the polymer membrane 150 by adhesive layer 155.

The primary backing 120 is a supportive scrim through which the tufts are tufted, and frequently is polyolefin, such as polyethylene or polypropylene; however, other materials such as polyester (including, for example, PET) can be used. For example, slit tapes made from PET may be used. The face yarn 110 may be made from various materials, both natural and synthetic, such as nylon 6, nylon 6,6, cotton, wool, nylon, acrylic, polyester, polyamides, polypropylene, and other polyolefins. The face weight of the face yarn 110 can be approximately 5 ounces per square yard to approximately 50 ounces per square yard.

The primary backing 120 may be formed from a substrate such as a woven substrate, a tape yarn substrate, and/or other substrate construction that imparts stability to the carpet tile 100. The substrate may be made from a polyester, such as poly(ethylene terephthalate) [PET], poly(trimethylene terephthalate) [PTT], poly(butylene terephthalate) [PBT], poly(ethylene terephthalate-co-isophthalate), poly(ethylene naphthalenedicaroxylate) [PEN], and copolymers thereof, and/or combinations thereof, with PET being preferred. In certain embodiments, the primary backing 120 may comprise a low melt polyester material configured to bind the various fibers together upon application of heat to the primary backing. The substrate may also comprise sheathed fibers, which may comprise a polyester core surrounded by a polyamide and/or polyolefin sheath. Typically, the polyester core may be made from PET, PTT, PBT, PEN, poly(ethylene terephthalate-co-isophthalate) and copolymers thereof. The polyamide sheath may be made from polycaprolactam [nylon 6], poly(7-heptanamide) [nylon 7], polycapryllactam [nylon 8], poly(9-nonanamide) [nylon 9], poly(tetramethylene adipamide) [nylon 4,6], poly(hexamethylene adipamide) [nylon 6,6], poly(methylene-4,4′-dicyclohexylene dodecanediamede), poly(1,4-cyclohexylenedimethulene suberamide), poly(m-phenylene isophthalamide), and poly(p-phenylene terephthalamide), with polycaprolactam [nylon 6] being the preferred polyamide. In certain embodiments, the primary backing 120 may be formed using a woven substrate using any conventional natural or synthetic woven material, such as cotton, jute, rayon, paper, nylon, polypropylene and other polyolefins, polyamides, polyesters, and the like.

The face yarn 110 may be tufted through the primary backing 120 so that the ends of the face yarn 110 extend in an outwardly direction from the topside of the primary backing 120 to form an upper surface of the carpet tile 100. Typically, the face yarn 110 is tufted into the primary backing 120 at a weight of approximately 2.6 ounces per square yard to approximately 5.9 ounces per square yard, and more preferably approximately 3 ounces per square yard. The tufting may be performed using conventional techniques that are well known in the art. Furthermore, the tufted face yarn 110 loops may be left as uncut to form an uncut pile carpet, cut to form a cut pile carpet, or partially cut to form a tip sheared carpet, as is well known in the art.

Optionally disposed on a bottom surface of the facecloth 130, according to the embodiment of FIG. 1, is a reinforced woven synthetic layer 170, secured by an adhesive layer 175. The reinforced woven synthetic layer 170, if present, imparts dimensional stability to the finished carpet tile 100.

The reinforced woven synthetic layer 170 may comprise a fibrous material provided in a woven configuration. The fibrous materials themselves may constitute any number of natural or synthetic materials. For example, the fibrous materials may be embodied as glass fibers. The fibrous material may additionally and/or alternatively comprise one or more polymer based fibers, such as polyester fibers, polyamide fibers, polyurethane fibers, combinations thereof, and/or the like. For example, the polymer fibers may comprise polypropylene fibers, polyethylene fibers, sheathed polymer fibers (e.g., having a polyethylene core and a nylon or polypropylene sheath), and/or the like. As yet another example, the fibrous material may comprise a composite of polymer-based fibers and other fibers (e.g., glass fibers). Such a composite may comprise layers of non-woven and/or woven layers (e.g., a first layer comprising a polymer-based fiber material and a second layer comprising a glass fiber material).

The adhesive layer 175, if present, may comprise any adhesive suitable for adhering layers of carpet together. The adhesive is preferably a thermoset adhesive.

The polymer membrane 150 is typically a polyester film membrane. It is preferably formed via extrusion of a polymer resin. The polymer membrane 150 is also preferably liquid-impermeable and non-breathable. The polymer membrane 150 is also non-porous, or microporous (i.e., having pores with a diameter<2 nm).

The resin of the polymer membrane 150 may include a polyolefin or a mixture of one or more polyolefins, and may further include one or more other polymers. For example, the resin may include polyethylene and/or polypropylene. As specific examples, the polyolefin polymer is embodied as 1-propene, ethylene copolymer or ethylene-propylene copolymer. In certain embodiments, the resin of the polymer membrane 150 includes the polyolefin or polyolefin mixture in an amount between about 10-99 wt % of the resin of the polymer membrane 150 (and of the polymer membrane 150 itself).

The resin used to form the polymer membrane 150 may additionally include one or more additives, such as an inert filler material, a colorant, an antioxidant, a tackifier, a viscosity modifier, a flame retardant, and/or the like.

The inert filler material may be made from carbonates such as calcium carbonate (CaCO₃), cesium carbonate (CsCO₃), strontium carbonate (SrCO₃), and magnesium carbonate (MgCO₃); sulfates such as barium sulfate (BaSO₃); oxides such as iron oxide (Fe₂O₃ or Fe₃O₄), aluminum oxide (Al₂O₃), tungsten oxide (WO₃), titanium oxide (TiO₂), silicon oxide (SiO₂); silicates, such as clay; metal salts; fly ash and the like.

Additionally, the inert filler material may be made completely or in part from post-consumer or post-industrial (pre-consumer) recycled products, such as glass, carpets and/or other recycled materials. In cases where the inert filler is made from recycled glass, the recycled glass is ground into a fine glass powder before it is added as filler. The glass cullet may be made from automotive and architectural glass, also known as plate glass, flint glass, E glass, borosilicate glass, brown glass (bottle glass), green glass (bottle glass), and coal fly ash, or a combination thereof. In the case where recycled carpet is used as the inert filler material, the recycled carpet may be ground into a fine cullet and added to the hot melt adhesive. In addition to the recycled carpet, remnants and trimmings of carpet (e.g., comprising trim waste from cutting carpet tiles from rolls of carpet, sometimes referred to as window waste), fine waste fibers that are a result of the shearing process, and the like, that are produced as a by-product during the manufacturing process may also be used to form the inert filler material.

The filled or unfilled polymer may also contain a colorant, such as carbon black or other colorant(s) to provide color and increase the opaqueness of the polymer membrane 150. Typically, the colorant may be present in an amount less than or equal to approximately 1 wt % the filled or unfilled resin and polymer membrane 150. For example, the colorant may be present in an amount between about 0.1-0.5 wt % of the polymer membrane 150. As a specific example, the colorant may be present in an amount of approximately 0.1 wt % of the resin and the polymer membrane 150.

Moreover, to reduce the possibility of thermo-oxidation degradation, the polymer in the resin may also contain one or more antioxidants. Some suitable antioxidants include, but are not limited to amines, 2,2′-methylene bis-(4-methyl-6-tert-butylphenol), 2,4,6-tri-tert-butylphenol, 2,6-di-tert-butyl-4-methylphenol, 4,4′-thio-bis-(6-tert-butyl-m-cresol), butylated hydroxy anisole, butylated hydroxy toluene, bis(hydrogenated tallow alkyl), oxide; tris(2,4-ditert-butylphenyl)phosphite and 1,3,5 triazine-2,4,6(1H, 3H, 5H)-tri one, 1,3,5, tris((3,5-(1-dimethylethyl))-4-hydroxyphenyl)methyl. Typically, the antioxidant may be present in the filled or unfilled polymer membrane 150 in an amount less than or equal to approximately 2 wt % of the resin and/or the polymer membrane 150, such as between about 0.05-0.5 wt % of the resin and/or the polymer membrane 150.

Moreover, the polymer membrane 150 may additionally include one or more tackifiers to aid in forming a strong mechanical bond with other layers.

The resin of the polymer membrane 150 may additionally include one or more viscosity modifiers and/or compatibilizers, such as, for example, olefins of higher or lower molecular weight than the resin discussed herein or ethylene maleic anhydride copolymer, to ensure proper flow and bonding of the resin within filler and polymers when applying onto a woven or nonwoven layer. The viscosity modifier may be present in an amount between about 0.1-3 wt % of the resin and the polymer membrane 150.

In certain embodiments, the resin of the polymer membrane 150 may additionally comprise one or more flame retardants, such as, but not limited to, aluminum trihydrate (ATH) or magnesium hydroxide (MgOH) for applications where flame-retardancy is desired. One or more flame retardants may be necessary to comply with applicable regulations regarding the installation and/or usage of carpet tiles in aircraft.

The adhesive layer 155 may comprise any adhesive suitable for adhering layers of carpet together. The adhesive is preferably a thermoset adhesive.

The nonwoven fabric 140 may comprise a fibrous material provided in a woven configuration, and aids in preventing shrinkage or expansion of the resulting carpet tile 100.

The fibrous material itself may constitute any number of natural or synthetic materials. For example, the fibrous material may be embodied as glass fibers. The fibrous material may additionally and/or alternatively include one or more polymer based fibers, such as polyester fibers, polyamide fibers, polyurethane fibers, combinations thereof, and/or the like. For example, the polymer fibers may include polypropylene fibers, polyethylene fibers, sheathed polymer fibers (e.g., having a polyethylene core and a nylon or polypropylene sheath), and/or the like. As yet another example, the fibrous material may comprise a composite of polymer-based fibers and other fibers (e.g., glass fibers). Such a composite may include layers of non-woven and/or woven layers (e.g., a first layer comprising a polymer-based fiber material and a second layer comprising a glass fiber material).

As mentioned, the nonwoven fabric 140 will further include a plurality of loops 145 which may form the loop part of a hook-and-loop system. In embodiments, the loops 145 are present on the nonwoven fabric 140 at a density of ≥50, ≥100, ≥200, ≥300, ≥400, ≥500, ≥600, ≥700, ≥800, ≥900, ≥1,000, ≥1,100, ≥1,200, ≥1,300, ≥1,400, ≥1,500, ≥1,600, ≥1,700, ≥1,800, ≥1,900, or ≥2,000 per square inch or square centimeter. In embodiments, the loops 145 are present at a density of 50-2,000 per square inch or square centimeter.

In an embodiment, the barrier backing 160 is formed separately, and then attached to either the primary backing 120 or the reinforced woven synthetic layer 170, possibly by an adhesive.

Flooring

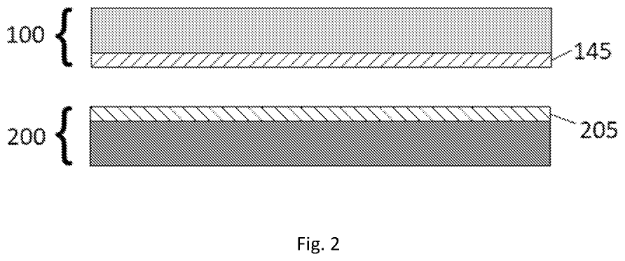

FIG. 2 schematically (not to scale) shows the carpet tile 100 in close proximity to a flooring 200, which is bound to an aircraft floor (not shown). The flooring 200 comprises a plurality of hooks 205 which may form the hook part of a hook-and-loop system, for coupling with the loops 145 of the carpet tile 100. Accordingly, the hooks 205 will be capable of coupling with the carpet tile 100 even without the addition of loops other than those naturally present within the barrier backing 160. The hooks 205 may be attached directly to the aircraft floor, or may be part of a larger flooring component which is itself bound to the aircraft floor.

In embodiments, the hooks 205 are present on the flooring 200 at a density of ≥50, ≥100, ≥200, ≥300, ≥400, ≥500, ≥600, ≥700, ≥800, ≥900, ≥1,000, ≥1,100, ≥1,200, ≥1,300, ≥1,400, ≥1,500, ≥1,600, ≥1,700, ≥1,800, ≥1,900, or ≥2,000 per square inch or square centimeter. In embodiments, the hooks 205 are present at a density of 50-2,000 per square inch or square centimeter.

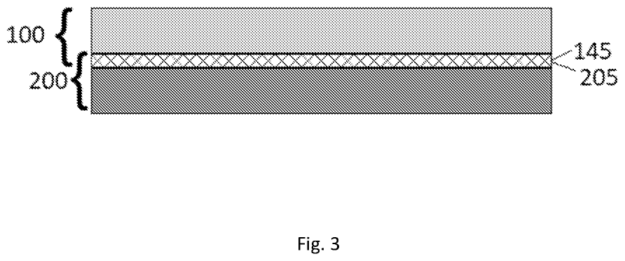

FIG. 3 schematically (not to scale) shows the carpet tile 100 coupled to the flooring 200 by the engagement of the loops 145 and hooks 205.

In an embodiment, the coupled hook-and-loop system exhibits a peel strength of ≥1, ≥2, ≥3, ≥4, ≥5, ≥6, ≥7, ≥8, ≥9, or ≥10 pounds per inch of width (PIW), as measured according to ASTM D5170. In an embodiment, the coupled hook-and-loop system exhibits a peel strength of 1-10 PIW.

In an embodiment, the coupled hook-and-loop system exhibits a shear strength of ≥5, ≥10, ≥15, ≥20, ≥25, ≥30, ≥35, ≥40, ≥45, ≥50, ≥55, ≥60, ≥65, ≥70, ≥75, ≥80, ≥85, or ≥90 pounds per square inch (psi) as measured according to ASTM D5169. In an embodiment, the coupled hook-and-loop system exhibits a shear strength of 5-90 psi.

In an embodiment, the coupled hook-and-loop system exhibits a tension strength of ≥5, ≥10, ≥15, ≥20, ≥25, ≥30, ≥35, ≥40, or ≥45 pounds per square inch (psi). In an embodiment, the coupled hook-and-loop system exhibits a tension strength of 5-45 psi. Tension strength may be measured by pulling apart a coupled hook-and-loop system by applying force to the entirety of each side of the system, as opposed to concentrating the force at an edge of the system, as in the peel test exemplified in ASTM D5170.

The hooks 205 may be part of a commercially-available hook-and-loop system, such as those commercially available under the name VELCRO (Velcro USA, Manchester, NH). The hook part of the commercially-available hook-and-loop system may be used without the counterpart loop part, as the hooks 205 will be selected to be compatible with (i.e., able to be coupled with) the loops 145 of the carpet tile 100. Specifically, the hooks 205 will be compatible with the loops 145 that form part of the nonwoven fabric 140.

The loops inherently present in the barrier backing allow the barrier backing to serve both as a moisture membrane and to adhere the carpet tile to the aircraft floor, without the addition of a loop part of a hook-and-loop system to the carpet. In doing so, a weight—and cost-savings benefit is realized, as neither the cost nor added weight of the loop part is required.

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. An aircraft floor covering system, said system comprising:
a) a carpet tile, said carpet tile comprising a barrier backing, said barrier backing comprising a top surface and a bottom surface, said top surface adhered to a polymer membrane, said bottom surface comprising a loop part of a hook-and-loop system; and
b) a hook part of a hook-and-loop system adhered to an aircraft floor, wherein the barrier backing is coupled to the hook part of the hook-and-loop system.

2. The system of claim 1, wherein said polymer film membrane is a polyester membrane.

3. The system of claim 1, wherein said carpet tile comprises a facecloth, wherein the facecloth comprises a primary backing having a plurality of face yarns extending through the primary backing.

4. The system of claim 3, wherein adhesive is present between the primary backing and the polymer membrane.

5. The system of claim 1, wherein said bottom surface of said barrier backing comprises loops in a density of ≥500 loops per square inch.

6. The system of claim 1, wherein said hook part of said hook-and-loop system comprises hooks in a density of ≥500 hooks per square inch.

7. The system of claim 1, wherein said hook-and-loop system, when coupled, exhibits a peel strength of ≥1, ≥2, ≥3, ≥4, ≥5, ≥6, ≥7, ≥8, ≥9, or ≥10 pounds per inch of width (PIW), as measured according to ASTM D5170.

8. The system of any one of claim 1, wherein said hook-and-loop system, when coupled, exhibits a shear strength of ≥5, ≥10, ≥15, ≥20, ≥25, ≥30, ≥35, ≥40, ≥45, ≥50, ≥55, ≥60, ≥65, ≥70, ≥75, ≥80, ≥85, or ≥90 pounds per square inch (psi) as measured according to ASTM D5169.

9. The system of claim 1, wherein said hook-and-loop system, when coupled, exhibits a tension strength of ≥5, ≥10, ≥15, ≥20, ≥25, ≥30, ≥35, ≥40, or ≥45 pounds per square inch (psi).

10. The system of claim 1, wherein said carpet tile further comprises a woven synthetic layer disposed between the polymer membrane and the primary backing.

11. The system of claim 10, wherein adhesive is present between the woven synthetic layer and each of the primary backing and the polymer membrane.

12. The system of claim 11, wherein the adhesive between the woven synthetic layer and the primary backing is the same as the adhesive between the woven synthetic layer and the polymer membrane.

13. The system of claim 11, wherein the adhesive between the woven synthetic layer and the primary backing is different from the adhesive between the woven synthetic layer and the polymer membrane.

14. The system of claim 1, wherein the hooks are attached directly to the aircraft floor.

15. The system of claim 1, wherein the hooks are part of a flooring component which is bound to the aircraft floor.

16. The system of claim 1, wherein the weight of the carpet tile is between about 30-60 ounces per square yard.

17. The system of claim 16, wherein the weight of the carpet tile is between about 40-50 ounces per square yard.

18. The system of claim 1, wherein the weight of the carpet tile and flooring, combined, is between about 40-90 ounces per square yard.

19. The system of claim 18, wherein the weight of the carpet tile and flooring, combined, is between about 50-70 ounces per square yard.
